(19) United States
(12) Patent Application Publication
(10) Pub. No.: US 2024/0177508 A1
(43) Pub. Date: May 30, 2024

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: KOTARO MATSUDA, Kanagawa (JP)

(21) Appl. No.: 18/507,522

(22) Filed: Nov. 13, 2023

(30) Foreign Application Priority Data
Nov. 29, 2022 (JP) 2022-190258

(51) Int. Cl. G06V 30/14; G06V 30/40

(52) U.S. Cl. CPC G06V 30/1448; G06V 30/40

(57) ABSTRACT

The information processing apparatus capable of communicating with an external device includes a first instruction unit configured to cause a first external device having a scan function to scan a document, a display unit configured to display a UI screen to receive a user operation for performing file transmission of a document image obtained by the scan, and a second instruction unit configured to cause a second external device, which has a function to obtain the document image from the first external device and perform file transmission, to perform file transmission of the document image based on a user operation received via the UI screen.

### BACKGROUND

### Field

The present disclosure relates to a scanned document management technique.

### Description of the Related Art

In recent years, there is a trend for the cloud service to be utilized for business applications. Accompanying this, there are increasing needs to scan a paper document by a scanner device (computerization of paper document) and transmit a document file, which is obtained by attaching a file name, metadata and the like to the obtained document image, to a business application. Japanese Patent Laid-Open No.2019-068324 has disclosed a method in which a document image obtained by a scan in a multi function peripheral is subjected to OCR (Optical Character Recognition) processing and the obtained recognized character string is utilized as the name of the transmission destination folder or the file name of the document file.

In Japanese Patent Laid-Open No. 2019-068324 described above, a method is described in which a UI (User Interface) for selecting a character string recognized by OCR processing from a preview-displayed document image and setting a file name or the like is provided on a touch panel of a multi function peripheral. However, in order to provide the UI on which it is possible to preview-display the document image, select the OCR processing-target character area, display the character string recognized by the OCR processing, and so on, it is necessary to comprise a touch panel having a size and resolution to a certain extent. In a case where a paper document is scanned in a company or the like, various devices having the scan function (in the following, called “scanner device”), such as a multi function peripheral or a scan-dedicated terminal, are utilized, and there are various model types of scanner device ranging from a high-end device to a low-end device. Then, for example, a compact or low-end model does not comprise a display having a size and resolution enough for the UI in many cases. In a case where the scanner device does not comprise a display having a size and resolution enough for the UI, it is not possible to provide the advanced UI function utilizing OCR processing such as that disclosed in Japanese Patent Laid-Open No.2019-068324 described above.

### SUMMARY

The information processing apparatus according to the present disclosure is an information processing apparatus capable of communicating with an external device and includes one or more memories storing instructions; and one or more processors executing the instructions to perform: giving first instructions to cause a first external device having a scan function to scan a document; displaying a UI screen on a display unit, which receives a user operation for performing file transmission of a document image obtained by the scan; and giving second instructions to cause a second external device, which has a function to obtain the document image from the first external device and perform file transmission, to perform file transmission of the document image based on a user operation received via the UI screen.

Further features of the present disclosure will become apparent from the following description of exemplary embodiments with reference to the attached drawings.

### BRIEF DESCRIPTION OF THE DRAWINGS

FIG. 1 is a diagram showing a configuration example of a document management system;

FIG. 2 is a hardware configuration diagram of an information processing apparatus;

FIG. 3 is a diagram showing one example of a software configuration of the document management system;

FIG. 4 is a sequence diagram showing a flow of processing in the document management system;

FIG. 5A to FIG. 5E are each a UI screen example of a multi function peripheral;

FIG. 6 is a sequence diagram showing a flow of processing in the document management system;

FIG. 7A to FIG. 7D are each a UI screen example of a client terminal;

FIG. 8A is a UI screen example of the multi function peripheral and FIG. 8B and FIG. 8C are each a UI screen of the client terminal;

FIG. 9 is a sequence diagram showing a flow of processing in the document management system;

FIG. 10A to FIG. 10D are each a UI screen example of the client terminal;

FIG. 11 is a sequence diagram showing a flow of processing in the document management system;

FIG. 12A and FIG. 12B are each a UI screen example of the client terminal;

FIG. 13 is a sequence diagram showing a flow of processing in the document management system;

FIG. 14A and FIG. 14B are each a UI screen example of the client terminal;

FIG. 15 is a sequence diagram showing a flow of processing in the document management system;

FIG. 16A to FIG. 16C are each a UI screen example of the client terminal;

FIG. 17 is a sequence diagram showing a flow of processing in the document management system;

FIG. 18A to FIG. 18C are each a UI screen example of the client terminal;

FIG. 19 is a sequence diagram showing a flow of processing in the document management system;

FIG. 20A to FIG. 20D are each a UI screen example of the client terminal;

FIG. 21 is a sequence diagram showing a flow of processing in the document management system;

FIG. 22 is a sequence diagram showing a flow of processing in the document management system;

FIG. 23A to FIG. 23C are each a UI screen example of the client terminal; and

FIG. 24A and FIG. 24B are each a diagram explaining another embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### System Configuration

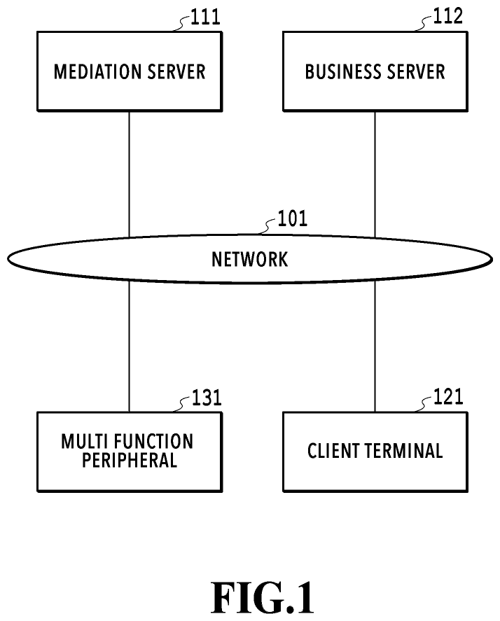

FIG. 1 is a diagram showing a configuration example of a document management system according to the present embodiment. The document management system shown in FIG. 1 includes a mediation server 111, a business server 112, a client terminal 121, and a multi function peripheral 131 capable of communicating with one another via a network 101, such as the internet and an intranet. The mediation server 111 is a server that provides an interface with the business server 112 and generally comprises the following four functions. First, the mediation server 111 has a function to receive and analyze a document image (scanned image) from a scanner device and transmits the document image to the destination business server as a document file. Next, the mediation server 111 has a function to manage cooperation with a plurality of business applications and transmit a document file to the selected destination business application. Further, the mediation server 111 also has a function to recognize and extract a character string described in a document by performing OCR (Optical Character Recognition) processing for a target document image and a function to convert the file format of a document file. As the client terminal 121, for example, a personal computer, a laptop computer, a tablet computer, a smartphone or the like is included. The multi function peripheral 131 is one example of an apparatus having the scan function, and for example, may be a scan-dedicated terminal. The business server 112 is a server that provides business applications for file management, document management, order reception, accounting, adjustment of expenses and the like.

### Hardware Configuration

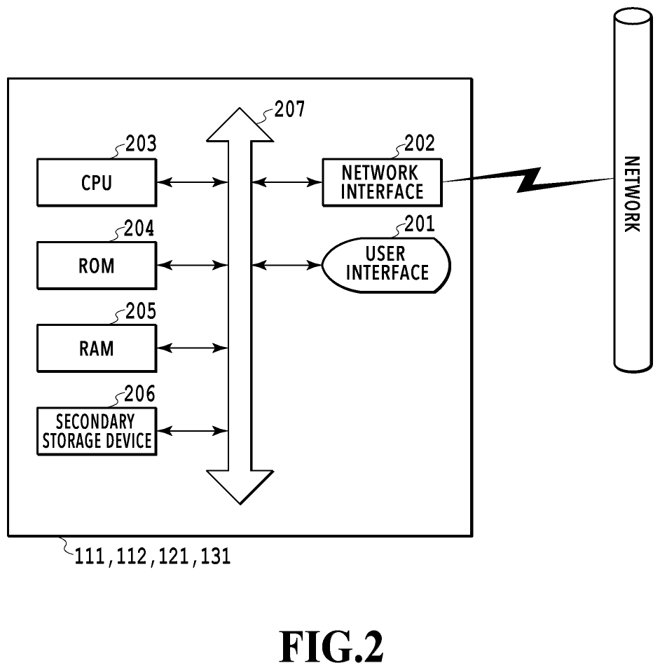

FIG. 2 is a diagram showing one example of the hardware configuration as an information processing apparatus common to mediation server 111, the business server 112, the client terminal 121, and the multi function peripheral 131. A user interface 201 inputs and outputs information and signals via a display, a keyboard, a mouse, a button, a touch panel and the like. A network interface 202 connects to a network, such as a LAN, and performs communication with another computer or a network device. The communication method may be a wired method or a wireless method. A CPU 203 is a central processing unit configured to execute a program read from a ROM 204, a RAM 205, a secondary storage device 206 or the like. The ROM 204 is a nonvolatile memory in which incorporated programs and data are stored. The RAM 205 is a volatile memory that provides a temporary memory area. The secondary storage device 206 is a large-capacity storage device, typically such as an HDD and a flash memory. It is also possible for another computer to connect to or operate a computer not comprising the hardware such as this by a remote desktop or remote shell. Each unit is connected via an input/output interface 207.

### Software Configuration

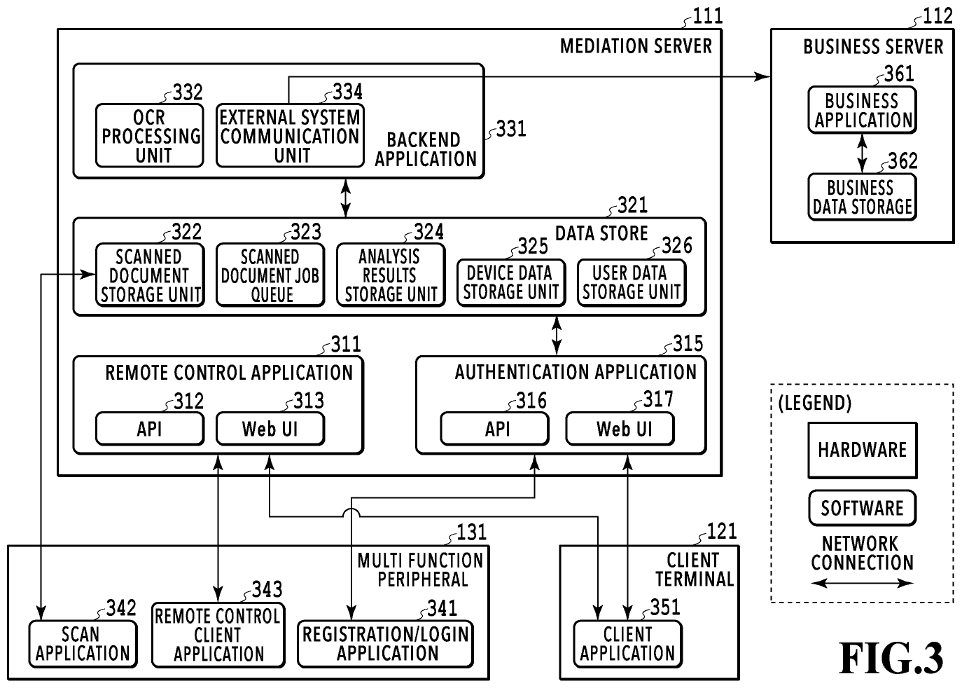

FIG. 3 is a diagram showing one example of the software configuration of the document management system according to the present embodiment. The configuration is such that each piece of software installed in each information processing apparatus is executed by the CPU 203 and communication is possible between apparatuses as shown schematically by a bidirectional arrow. In the following, each information processing apparatus is explained.

### Mediation Server

A remote control application 311 provides a Web application for operating as a Web application server. The remote control application 311 includes an API (Application Programming Interface) and a Web UI 313. The Web UI 313 includes a file group in conformity with the Web technique standard, such as HTML, CSS, and JavaScript.

An authentication application 315 is an application that identifies a device by authenticating connection from the multi function peripheral 131 and has an API 316 and a Web UI 317.

A data store 321 stores data that is used by the remote control application 311, the authentication application 315, or a backend application 331, to be described later. The data store 321 has a scanned document storage unit 322, a scanned document job queue 323, an analysis results storage unit 324, a device data storage unit 325, and a user data storage unit 326. The scanned document storage unit 322 stores a document file received from the multi function peripheral 131 in a predetermined format, such as JPEG (Joint Photographic Experts Group) and PDF (Portable Document Format). The scanned document job queue 323 stores a queue managing jobs waiting for transmission processing to a destination. The analysis results storage unit 324 stores analysis results, such as results of document image OCR processing that is performed by the backend application 331, to be described later. The device data storage unit 325 stores a list of information on devices connected to the mediation server 111. The above-described authentication application 315 receives a registration request from the multi function peripheral 131 and stores device information in the device data storage unit 325. The user data storage unit 326 stores a list of user information of the mediation server 111. The above-described authentication application 315 performs authentication processing and user identification by referring to user information within the user data storage unit 326.

The backend application 331 is an application in charge of processing that may be performed sequentially in the background. In the present embodiment, as background processing, there are document image OCR processing and document file transmission processing. An OCR processing unit 332 obtains a document image from the scanned document storage unit 322 and performs OCR processing. In the OCR processing, the starting point coordinates, width, and height of a character string area within the document image and a character string, which is recognition results, are extracted. The extracted character string is utilized for the generation of searchable PDF in which character string information is attached to the image. Further, as will be described later, the extracted character string is utilized for the generation of a folder name, a file name, metadata and the like at the time of transmission to a predetermined destination. An external system communication unit 334 performs processing to transmit a document file to the business server 112.

Each function that is provided by each application or the processing unit of the above-described mediation server 111 may be one that is provided as a cloud service. That is, the mediation server 111 may be a cloud server.

### Multi Function Peripheral

A registration/login application 341 is an application for registering the multi function peripheral 131 as a client of the mediation server 111 and for logging in to the mediation server 111. A scan application 342 is an application that generates a document image by driving a scanner (not shown schematically) of the multi function peripheral 131 and optically reading a set paper document. A remote control client application 343 is an application that is executed in the background within the multi function peripheral 131 and receives instructions from the remote control application 311 and drives the multi function peripheral 131. By transmitting an operation request from a client application 351 of the client terminal 121 to the remote control application 311, it is possible to transfer instructions from the remote control application 311 to the multi function peripheral 131.

### Client Terminal

The client application 351 is, in the present embodiment, an application that executes the Web application of the remote control application 311 of the mediation server 111. As one provision aspect of the client application 351, there is a method of executing the Web application by displaying the Web UIs 313 and 317 by a browser and performing transmission and reception of necessary data with the APIs 312 and 316. Alternatively, the provision aspect may be an application of a computer or smartphone, which is created so as to perform transmission and reception of necessary data with the APIs 312 and 316. In the latter case, the UI may be provided as a native application, or the Web UIs 313 and 317 may be displayed within the application by using Web View.

### Business Server

A business application 361 is an application that performs various types of work, such as file management, document management, order reception, accounting, adjustment of expenses and the like. A business data storage 362 is a storage that stores data that is used by the business application 361. The various types of work provided by the business application 361 of the business server 112 may be those provided as cloud services.

### Processing Flow of Document Management System

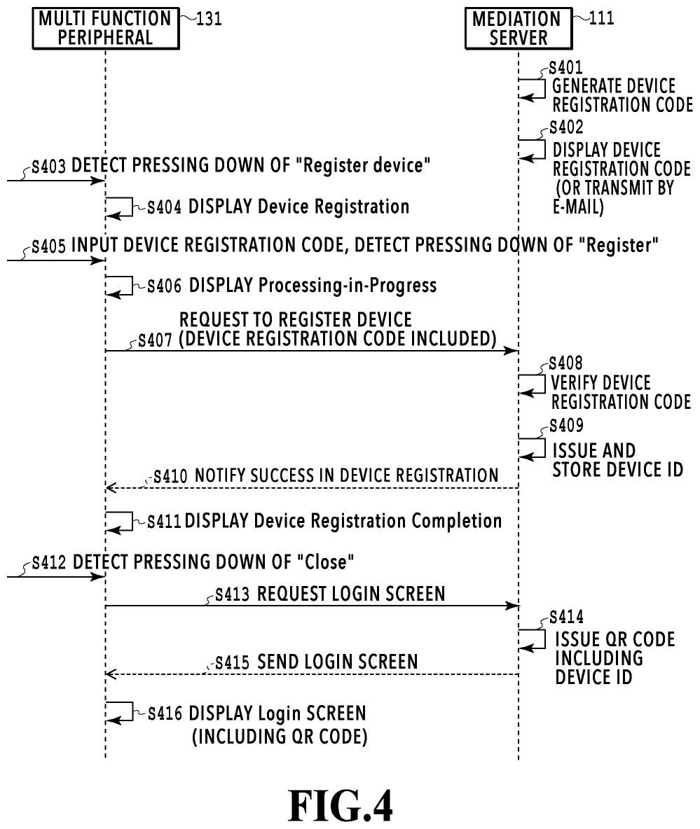

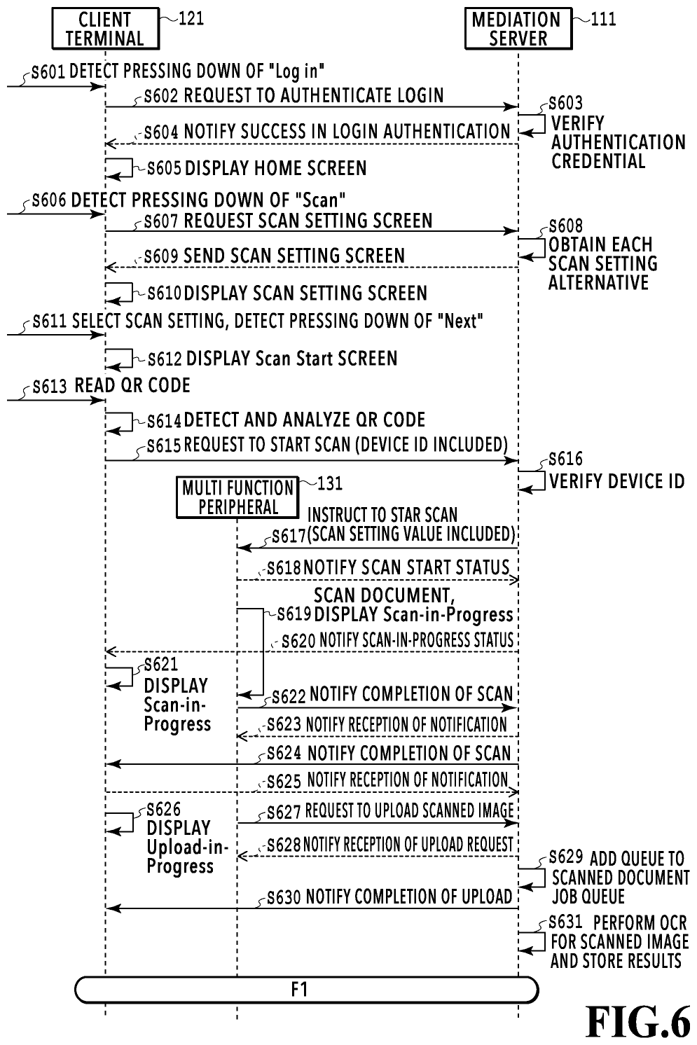

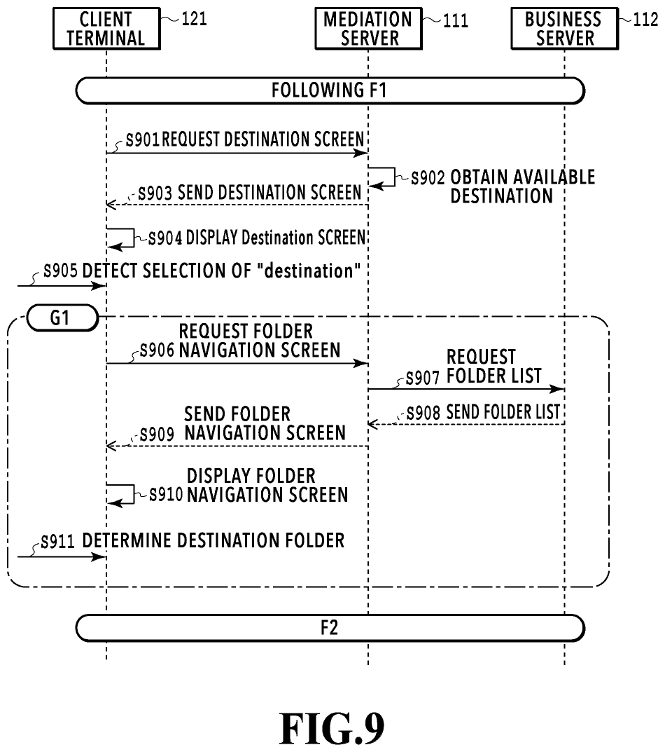

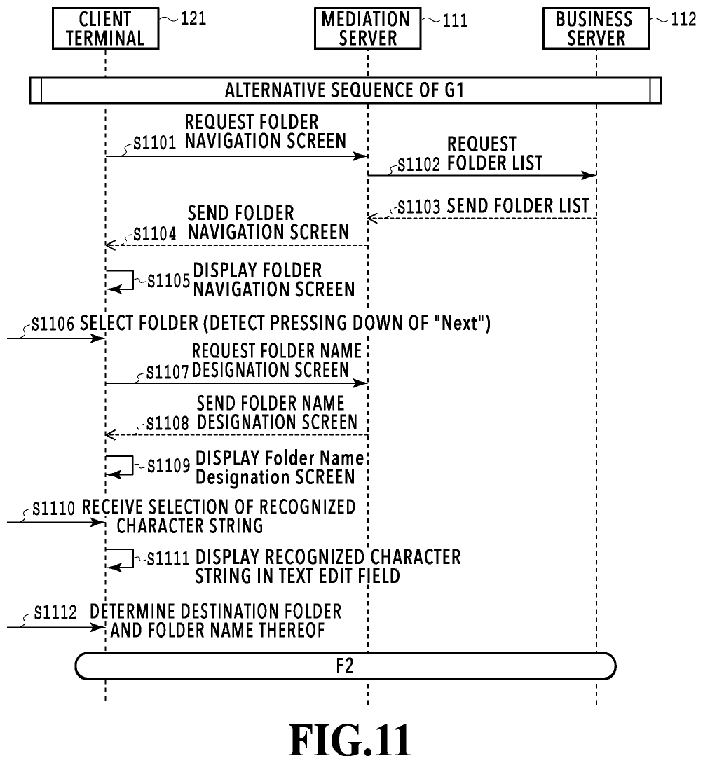

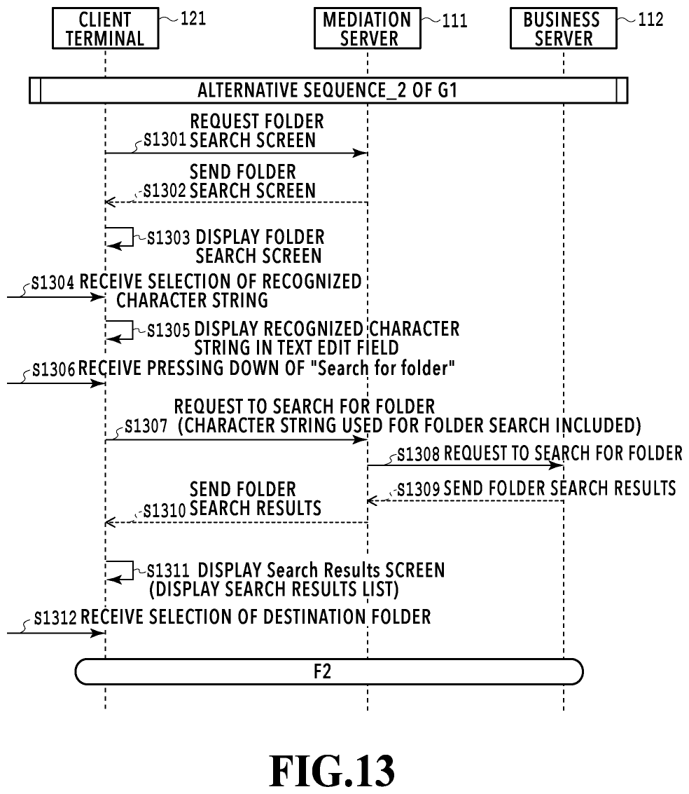

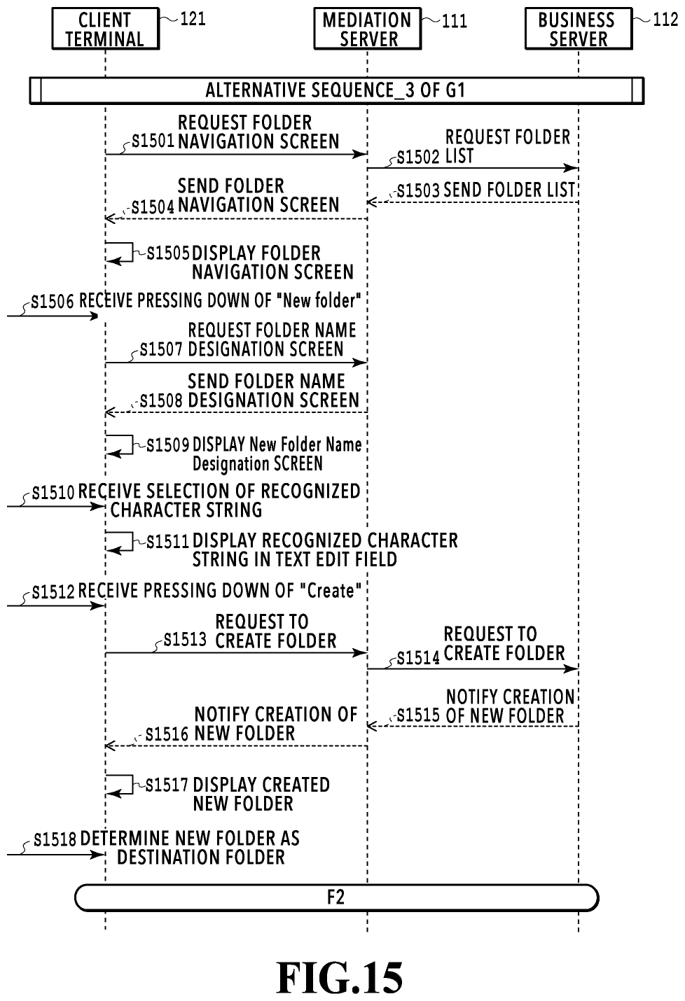

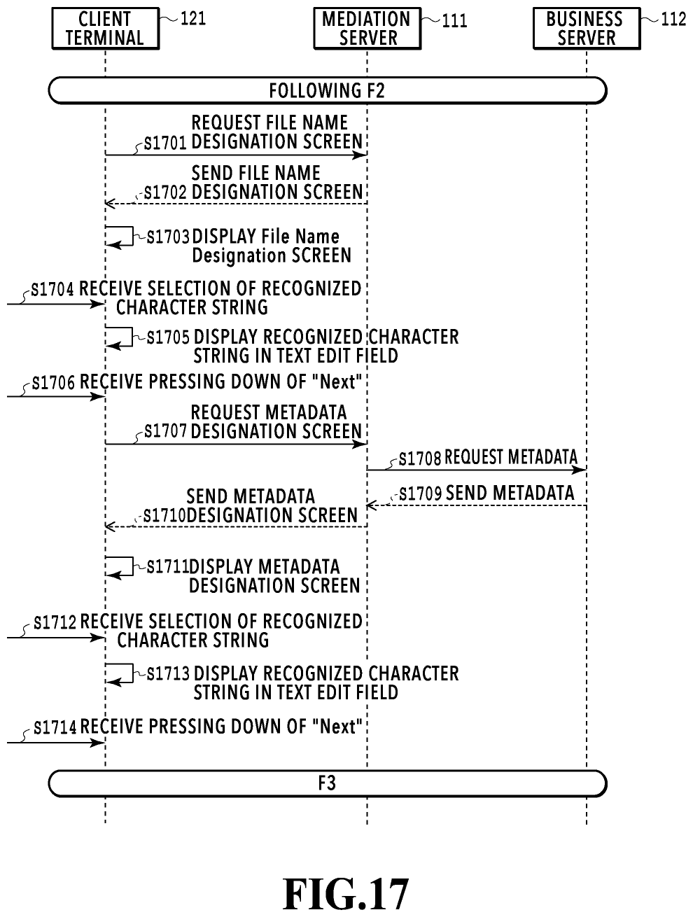

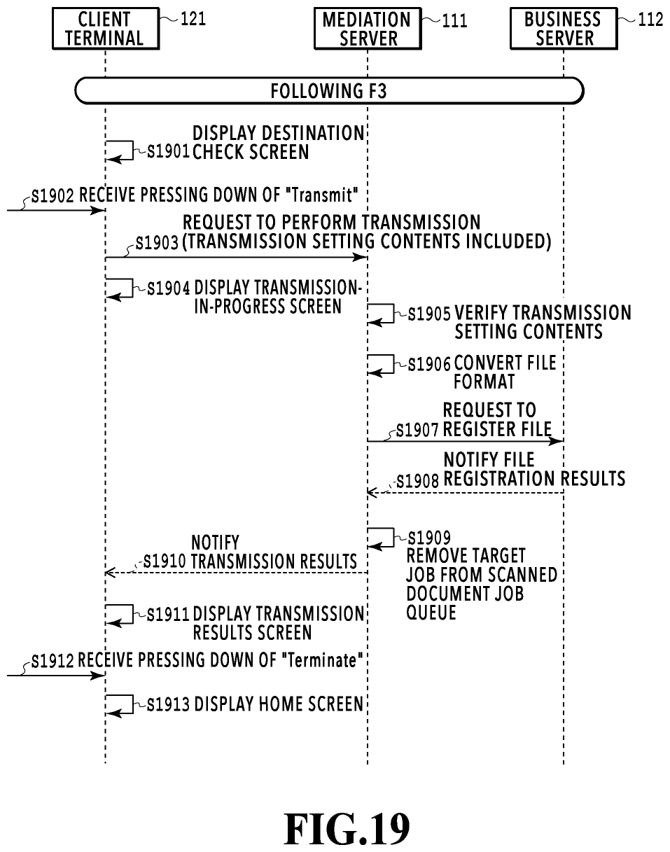

Following the above, a flow of the processing in the document management system according to the present embodiment is explained by using the sequence diagrams (FIG. 4, FIG. 6, FIG. 9, FIG. 11, FIG. 13, FIG. 15, FIG. 17, FIG. 19).

### Between Multi Function Peripheral and Mediation Server

FIG. 4 is a sequence diagram showing operations performed between the multi function peripheral 131 and the mediation server 111. First, the mediation server 111 generates a device registration code in advance (S401). The device registration code is a passcode for authenticating a device registration request to the mediation server 111, consisting of, for example, a 16-digit number. The device registration code may include English letters, symbols and the like other than numbers. In order to prevent the abuse of code, it may also be possible to generate and provide a new code periodically by providing the period of validity for the code, such as seven days. The device registration code generated by the mediation server 111 is displayed on the Web UI 317 of the authentication application 315 or provided to a management user by being transmitted by an E-mail (S402).

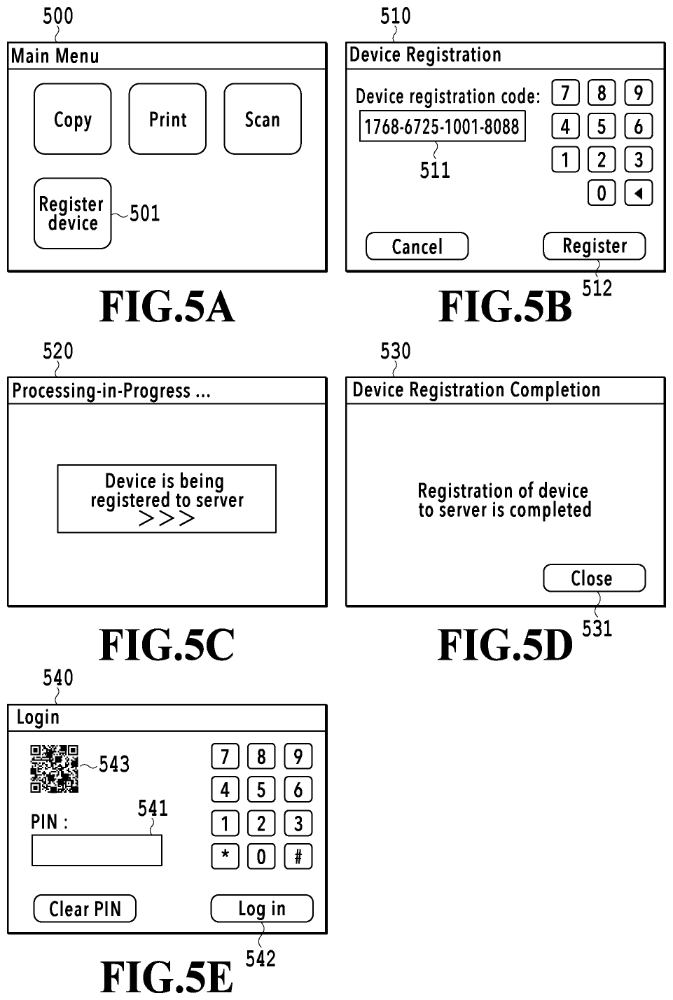

Next, the management user causes the multi function peripheral 131 to display a Main Menu UI screen 500 shown in FIG. 5A and presses down a “Register device” button 501. Upon detecting the pressing down of the “Register device” button 501 (S403), the registration/login application 341 displays a Device Registration screen 510 shown in FIG. 5B (S404). The management user inputs a valid device registration code obtained in advance to an edit control 511 and presses down a “Register” button 512. Upon detecting the pressing down of the “Register” button 512 (S405), the registration/login application 341 displays a Processing-in-Progress screen 520 shown in FIG. 5C (S406) Then, the registration/login application 341 requests the authentication application 315 to register a device (S407). In this device registration request, a device registration code is included.

Upon receipt of the device registration request, in the mediation server 111, the authentication application 315 verifies whether the device registration code included in the request is valid (S408). In a case where the verification succeeds, a device ID is issued as a unique identifier for managing device information. As the device ID, one capable of guaranteeing uniqueness, such as UUID, is used. The authentication application 315 stores the issued device ID in a management table as device information as shown in Table 1 below (S409). After this, upon receipt of a communication request from a device, the device is identified by the device ID and various requests are processed.

TABLE 1

| | | Model | Date of |
|---|---|---|---|
| Device ID | Device name | name | registration |
| dc6375d1-18a6-4793- | multi function | C3550 | 2022 Jun. |
| bc01-083a45e5ac31 | peripheral C3550 | | 10T03:33:39Z |
| | second floor | | |
| f73e91e-6e94-4945- | scanner S8870 | S8870 | 2022 Jun. |
| adfa-493d3b2df75d | | | 11T09:52:20Z |

Then, the authentication application 315 notifies the registration/login application 341 of the multi function peripheral 131 of the success in device registration (S410).

The registration/login application 341 of the multi function peripheral 131 having received the notification of the success in device registration displays a Device Registration Completion screen 530 shown in FIG. 5D (S411). Upon detecting the pressing down of a “Close” button 531 within the Device Registration Completion screen 530 (S412), the registration/login application 341 requests the authentication application 315 of the mediation server 111 to obtain a login screen (S413).

After this, the authentication application 315 of the mediation server 111 having received the request to obtain the login screen includes the device ID of its own in the HTTP header and the like. Then, the scan application 342 and the remote control client application 343, to be described later, of the multi function peripheral 131 also includes the device ID of its own in the HTTP header and the like. Alternatively, it may also be possible for the authentication application 315 to issue an access token/refresh token and for the registration/login application 341 of the multi function peripheral 131 to include the access token in a request without fail. The device ID is caused to be included in the access token without fail so as to enable the identification of the device ID. The authentication application 315 identifies the device ID included in the request, issues a QR code (registered trademark) including the device ID (S414), and sends a login screen to the registration/login application 341 of the multi function peripheral 131 (S415).

The registration/login application 341 of the multi function peripheral 131 having received the login screen displays a Login screen 540 shown in FIG. 5E (S416). The user logs in by inputting a device registration code including arbitrary numbers and character strings to a PIN input field 541 within the Login screen 540 and pressing down a Log in button 542. A QR code 543 is to be read by the client terminal 121 (see S613, to be described later). In a case where the multi function peripheral 131 does not comprise a large enough UI panel, it may also be possible to input a device registration code by another method. For example, it may also be possible to enable a device registration code to be input by connecting the multi function peripheral 131 and the client terminal 121 by wireless communication, such as Bluetooth, and displaying a UI screen for device registration code on the client terminal 121. It is possible for the client terminal 121 to transmit the input device registration code to the multi function peripheral 131 by wireless communication and for the multi function peripheral 131 to transmit a registration request to the mediation server 111 by using the received device registration code.

### Between Client Terminal, Mediation Server, and Multi Function Peripheral

Next, processing to log in to the mediation server 111 from the client terminal 121 and remotely operate the multi function peripheral 131 via the remote control application 311 of the mediation server 111 is explained. FIG. 6 is a sequence diagram showing operations performed between the client terminal 121, the mediation server 111, and the multi function peripheral 131.

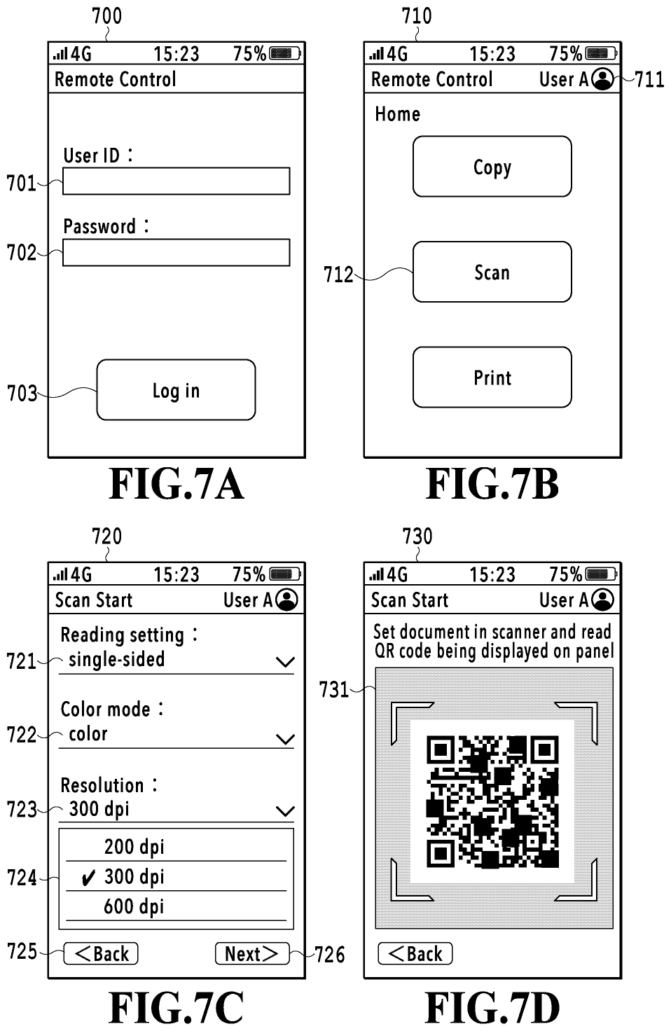

First, a user causes the client terminal 121 to display a login screen 700 shown in FIG. 7A. Then, the user inputs a combination of numbers and character strings, which is determined in advance, to a User ID input field 701 and a Password input field 702 (credential input) and presses down a “Log in” button 703. The client application 351 having detected the pressing down of the “Log in” button 703 (S601) requests the authentication application 315 of the mediation server 111 to authenticate the login (S602).

The authentication application 315 of the mediation server 111 verifies an authentication credential based on the login authentication request (S603). In a case where the verification succeeds, the authentication application 315 notifies the client application 351 of the client terminal 121 of the success in login authentication (S604).

The client application 351 of the client terminal 121 having received the notification of the success in login authentication displays a home screen 710 shown in FIG. 7B (S605). At this time, on the home screen 710, a character string 711 representing the name of the user having logged in is displayed. Following the above, upon detecting the pressing down of a Scan button 712 (S606), the client application 351 requests a scan setting screen from the remote control application 311 of the mediation server 111 (S607).

The remote control application 311 of the mediation server 111 having received the scan setting screen request gives a query about the device information to device data storage unit 325 by using the device ID included in the request and identifies the model type of the multi function peripheral 131. Following the above, the remote control application 311 obtains each scan setting alternative that can be utilized in the multi function peripheral 131 whose model type has been identified (S608) and sends a scan setting screen including the obtained alternative (S609).

The client application 351 of the client terminal 121 having received the scan setting screen displays a scan setting screen 720 shown in FIG. 7C (S610). In a Reading setting field 721 within the scan setting screen 720, it is possible to select single-sided, double-sided, automatic and the like. In a Color mode setting field 722, it is possible to select color, white and black, grayscale, automatic and the like. In a Resolution setting field 723, it is possible to select an alternative of an available resolution value. In each setting field, it is possible to select an alternative by pressing down the alternative in a dropdown selection control 724. Upon detecting the pressing down of a “Back” button 725, the client application 351 returns the display to the one previous home screen 710. Upon detecting the pressing down of a “Next” button 726 (S611), the client application 351 displays a Scan Start screen 730 shown in FIG. 7D (S612). A user reads the QR code 543 (see FIG. 5B) by using the image capturing function of the client terminal 121 by operating the client terminal 121 so that the QR code 543 is included within a camera image display area 731 on the Scan Start screen 730 (S613). The client application 351 extracts a device ID by detecting and analyzing the captured QR code (S614). Then, the client application 351 requests the remote control application 311 of the mediation server 111 to start a scan (S615). The scan start request is configured, for example, in the format of HTTP request URL as below.
https://{FQDN}/remoteoperation/scan/start?deviceid={UUID}

In the above-described HTTP request URL, “{FQDN} means “Fully Qualified Domain Name” of the mediation server 111. The request is routed to the remote control application 311 by the “/remoteoperation” path. The “/scan” path indicates that the scan function is used. The “/start” path indicates that a scan is requested to be started. The “?deviceid={UUID}” is a query character string and designates the remote operation-target device ID. This device ID is obtained by reading the QR code at S614.

The remote control application 311 of the mediation server 111 verifies the device ID included in the scan start request (S616). In a case where the verification succeeds, the remote control application 311 instructs the remote control client application 343 of the multi function peripheral 131 corresponding to the target device ID to start a scan (S617).

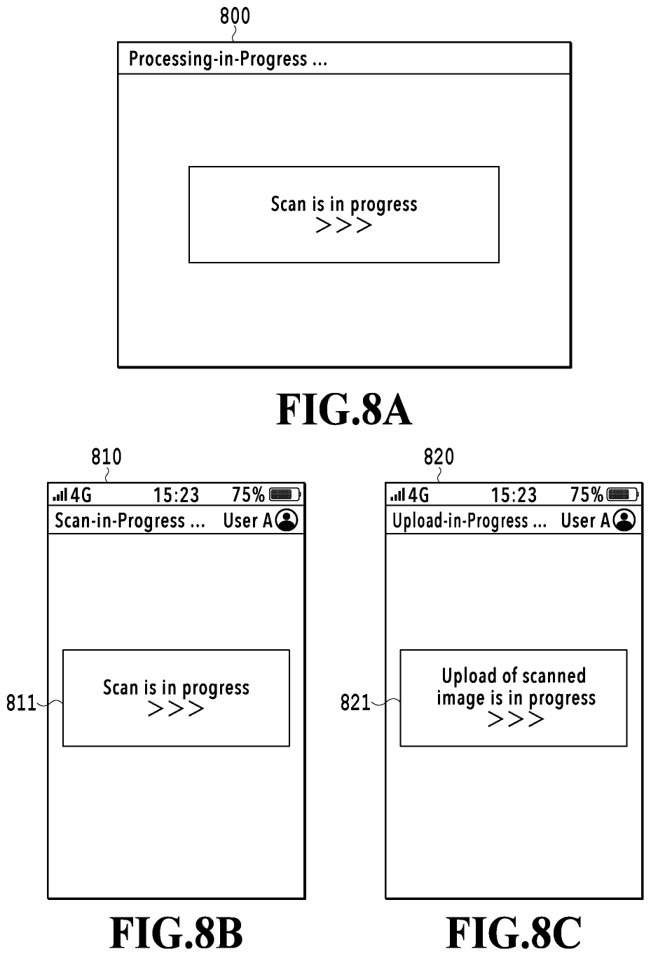

The remote control client application 343 of the multi function peripheral 131 notifies the remote control application 311 of the mediation server 111 of the scan start status (S618). Then, the scan application 342 starts to scan a document and displays a Processing-in-Progress screen 800 in FIG. 8A, indicating that the scan of the document is in progress (S619).

The remote control application 311 of the mediation server 111 having received the notification of the scan start status notifies the client application 351 of the client terminal 121 of the scan-in-progress status (S620). Then, the client application 351 displays a Scan-in-Progress screen 810 shown in FIG. 8B (S621). The Scan-in-Progress screen 810 includes a status message 811.

In a case where the scan of the document is completed, the scan application 342 of the multi function peripheral 131 notifies the remote control application 311 of the mediation server 111 of the completion of the scan via the remote control client application 343 (S622). The remote control application 311 having received the notification of the completion of the scan notifies the remote control client application 343 of the multi function peripheral 131 of the reception of the notification (S623). Further, the remote control application 311 of the mediation server 111 notifies the client application 351 of the client terminal 121 of the completion of the scan (S624).

The client application 351 of the client terminal 121 notifies the remote control application 311 of the mediation server 111 of the reception of the notification of the completion of the scan (S625). Further, the client application 351 displays an Upload-in-Progress screen 820 shown in FIG. 8C (S626). The Upload-in-Progress screen 820 includes a status message 821.

After the scan is completed, the scan application 342 of the multi function peripheral 131 requests the mediation server 111 to upload a document image (S627). The remote control application 311 of the mediation server 111 having received the upload request stores the document image in the scanned document storage unit 322 within the data store 321 and notifies the multi function peripheral 131 of the reception of the upload request (S628). Further, the remote control application 311 adds a queue to the scanned document job queue 323 within the data store 321 (S629). Then, the remote control application 311 notifies the client application 351 of the client terminal 121 of the completion of the upload (S630). In a case where a new queue is added to the scanned document job queue 323, the backend application 331 of the mediation server 111 causes the OCR processing unit 332 to perform OCR processing for the document image stored in the scanned document storage unit 322. Then, the backend application 331 stores the results of the OCR processing (recognized character string) in the analysis results storage unit 324 within the data store 321 (S631).

### Between Client Terminal, Mediation Server, and Business Server

Further, explanation is given with reference to the sequence diagram in FIG. 9, which is the sequence diagram following {F1} in the sequence diagram in FIG. 6. In the sequence diagram in FIG. 9, the multi function peripheral 131 does not appear and the operations are performed between the client terminal 121, the mediation server 111, and the business server 112.

The client application 351 of the client terminal 121 requests a destination screen from the remote control application 311 of the mediation server 111 (S901).

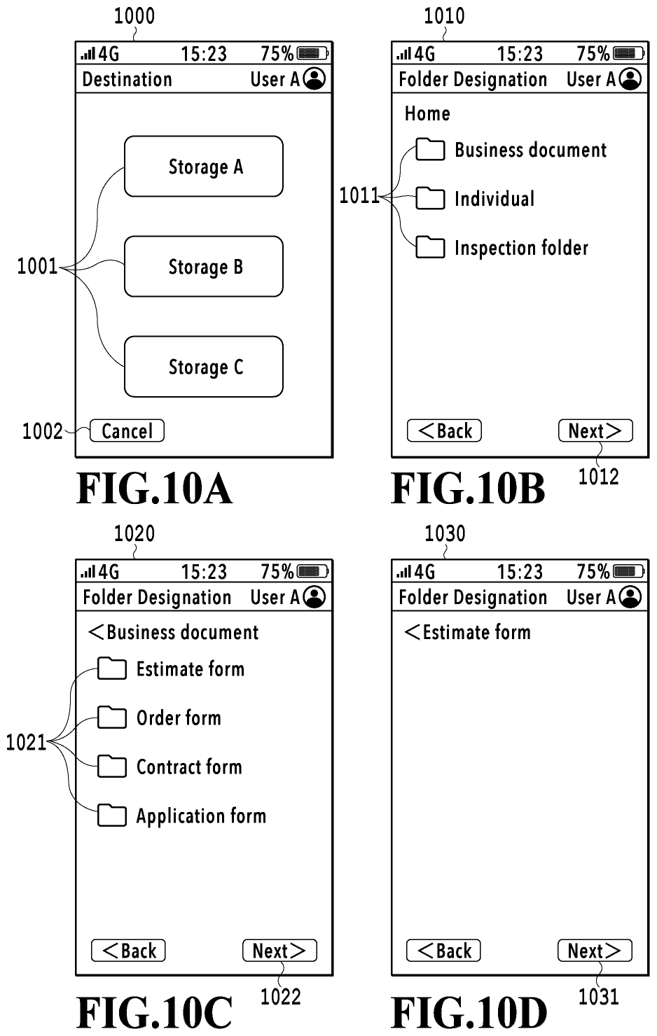

The remote control application 311 of the mediation server 111 having received the destination screen request obtains an available destination (S902). Then, the remote control application 311 sends a destination screen to the client terminal 121 (S903). The client application 351 of the client terminal 121 having received the destination screen displays a Destination screen 1000 shown in FIG. 10A (S904). The Destination screen 1000 is configured so as to be capable of receiving a user operation for designating the destination of file transmission. In a case where the pressing down of a “Cancel” button 1002 within the Destination screen 1000 is detected, the processing is aborted and the display returns to the home screen 710. On the other hand, in a case where the pressing down of one of destination buttons 1001 within the Destination screen 1000 is detected (S905), the client application 351 requests a folder navigation screen corresponding to the pressed-down destination button 1001 from the mediation server 111 (S906).

The remote control application 311 of the mediation server 111 requests a folder list from the business server 112 via the external system communication unit 334 (S907). The business application 361 of the business server 112 having received the request sends a folder list (S908). Then, the remote control application 311 of the mediation server 111 sends a folder navigation screen (S909).

The client application 351 of the client terminal 121 having received the folder navigation screen displays a folder navigation screen 1010 shown in FIG. 10B (S910). In a case where the pressing down of a “Next” button 1012 is detected in the state where one of folder icons 1011 is selected, the client application 351 obtains a lower layer folder list of the folder, which is indicated by the selected folder icon. Then, the client application 351 displays a folder navigation screen 1020 in the hierarchical layer one layer below. The folder navigation screen 1020 shown in FIG. 10C is an example of the folder navigation screen in the hierarchical layer one layer below in a case where the folder icon of a “Business document” folder is selected within the folder navigation screen 1010. Further, in a case where the pressing down of a “Next” button 1022 is detected in the state where one of folder icons 1021 is selected, the client application 351 obtains a lower layer folder list of the folder, which is indicated by the selected folder icon. Then, the client application 351 displays a folder navigation screen 1030 in the hierarchical layer one layer below. The folder navigation screen 1030 shown in FIG. 10D is an example of the folder navigation screen in the hierarchical layer further one layer below in a case where an “Estimate form” folder is selected within the folder navigation screen 1020. In a case where the pressing down of a “Next” button 1031 within the folder navigation screen 1030 is detected, the folder in the lowermost layer (here, folder whose folder name is “Estimate form”), which is the storage destination of the document file, is determined (S911). Then, the processing advances to file name and metadata designation processing shown in the sequence diagram in FIG. 17, to be described later.

### Modification Example 1

At S906 to S911 (G1 in FIG. 9) described above, in accordance with the folder navigation, a user manually selects and designates all the folders until the target storage destination folder in the lowermost layer is reached. Next, with reference to the sequence diagram in FIG. 11, which is the alternative sequence diagram of the {G1} portion in the sequence diagram in FIG. 9, a method is explained as a modification example 1, in which after a storage destination folder is designated, a folder name is designated by utilizing OCR processing results of a document image.

In a case where the pressing down of one of the destination buttons 1001 within the Destination screen 1000 is detected (S905), the client application 351 requests a corresponding folder navigation screen from the mediation server 111 (S1101). The remote control application 311 of the mediation server 111 requests a folder list from the business server 112 via the external system communication unit 334 (S1102). The business application 361 of the business server 112 having received the request sends a folder list (S1103). Then, the remote control application 311 of the mediation server 111 sends a folder navigation screen (S1104). The processing up to this point is the same as that of the GI portion in FIG. 9.

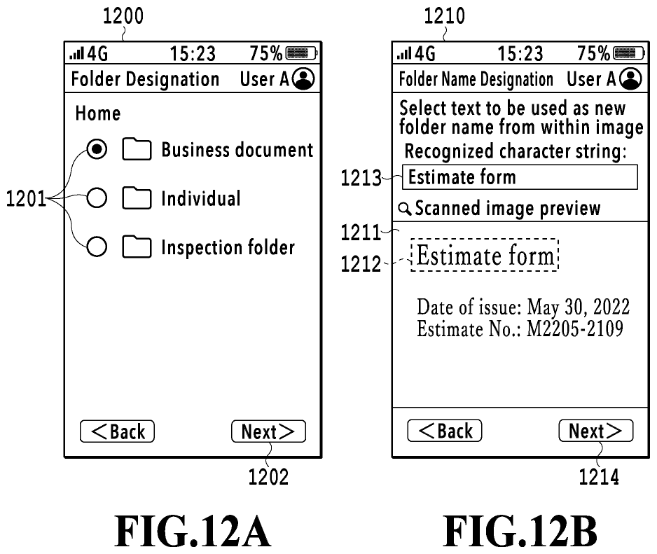

The client application 351 of the client terminal 121 having received the folder navigation screen displays a folder navigation screen 1200 shown in FIG. 12A (S1105). On the folder navigation screen 1200, radio buttons 1201 for a user to select a folder exist. The folder navigation screen 1200 differs from the folder navigation screen 1010 in FIG. 10B in that although it is possible to move to the lower layer folder by clicking the folder icon, in order to designate a desired folder, the corresponding radio button 1201 needs to be selected. Only in the case where the radio button 1201 corresponding to one of the folders is already selected, a “Next” button 1202 is valid. A user designates a storage destination folder by pressing down the “Next” button 1202 in the valid state, but in a case where the storage destination folder is in the lower hierarchical layer, the user repeats the pressing down of the “Next” button 1202 the number of times corresponding to the number of hierarchical layers through which the storage destination folder is reached. In this manner, it is possible for the user to designate the storage destination folder in an arbitrary hierarchical layer (S1106). Then, in a case where the designation of the storage destination folder is completed, the client application 351 requests a folder name designation screen from the remote control application 311 of the mediation server 111 (S1107).

The remote control application 311 of the mediation server 111 having received the request sends a folder name designation screen including the processing-target document image and the OCR processing results thereof (recognized character string list) (S1108).

The client application 351 of the client terminal 121 having received the folder name designation screen displays a Folder Name Designation screen 1210 shown in FIG. 12B (S1109). On the Folder Name Designation screen 1210, the processing-target document image is displayed within a preview area 1211. A user selects the area of a character string the user desires to use as a folder name from the document image being preview-displayed (here, it is assumed that a character string area 1212 of “Estimate form” is selected). The client application 351 detects the selection of the character string area such as this (S1110). The client application 351 displays the recognized character string corresponding to the character string area relating to the detected selection in a text edit field 1213 (S1111). In a case where there is an error in the displayed recognized character string, it may also be possible for the user to modify the erroneous character string to the correct character string in the text edit field 1213 by using, for example, a soft keyboard or the like. In a case where the pressing down of a “Next” button 1214 within the Folder Name Designation screen 1210 is detected, the name (here, “Estimate form”) of the designated storage destination folder is determined (S1112).

### Modification Example 2

Next, with reference to the sequence diagram in FIG. 13, which is the alternative sequence diagram of the {G1} portion in the sequence diagram in FIG. 9, a method is explained as a modification example 2, in which a target storage destination folder is designated by performing a folder search utilizing OCR processing results of a document image.

In a case where the pressing down of one of the destination buttons 1001 within the Destination screen 1000 in FIG. 10A is detected (S905), the client application 351 requests a folder search screen from the mediation server 111 (S1301). The remote control application 311 of the mediation server 111 having received the request sends a folder search screen including the document image and the OCR processing results thereof to the client terminal 121 (S1302).

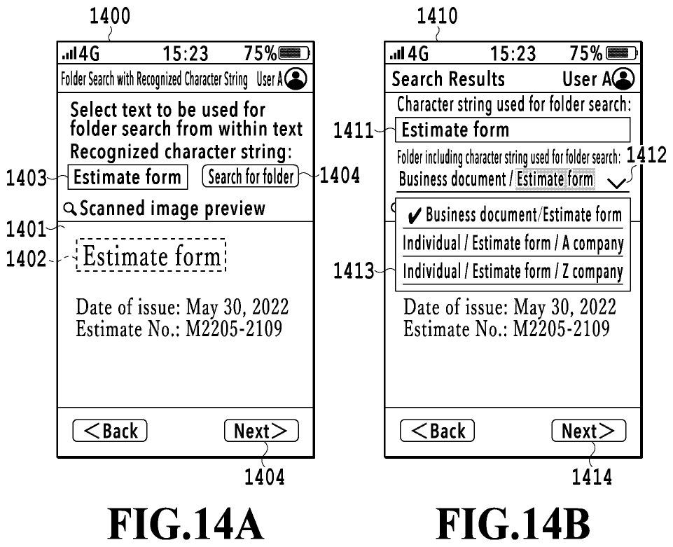

The client application 351 of the client terminal 121 having received the folder search screen displays a folder search screen 1400 shown in FIG. 14A (S1303). On the folder search screen 1400, the processing-target document image is displayed within a preview area 1401. A user selects the area of a character string the user desires to use for a search from the document image being preview-displayed (here, it is assumed that a character string area 1402 of “Estimate form” is selected). The client application 351 detects the selection of the character string area such as this (S1304). The client application 351 displays the recognized character string corresponding to the character string area relating to the detected selection in a text edit field 1403 (S1305). Upon detecting the pressing down of a “Search for folder” button 1404 (S1306), the client application 351 requests the remote control application 311 of the mediation server 111 to search for a folder (S1307). In this folder search request, the recognized character string (character string used for folder search) is included.

The remote control application 311 of the mediation server 111 requests the business server 112 to search for a folder via the external system communication unit 334 (S1308). The business application 361 of the business server 112 having received the request sends folder search results including the character string used for folder search (S1309).

The remote control application 311 of the mediation server 111 having received the folder search results sends the folder search results to the client application 351 of the client terminal 121.

The client application 351 of the client terminal 121 having received the folder search results displays a Search Results screen 1410 shown in FIG. 14B. On the Search Results screen 1410, a search results list 1413 including a recognized character string 1411 as the character string used for folder search is developed and displayed by a dropdown list control 1412 (S1311). Here, in the search results list 1413, three folder names including the character string used for folder search “Estimate form” are displayed as search results. In a case where the pressing down of a “Next” button 1414 is detected in the state where a specific folder name within the search results list is selected, the target storage destination folder (here, the folder whose folder name is “Business document/Estimate form”) is determined (S1312).

### Modification Example 3

Next, with reference to the sequence diagram in FIG. 15, which is the alternative sequence diagram of the {G1} portion in the sequence diagram in FIG. 9, a method is explained as a modification example 3, in which a new storage destination folder is created by utilizing OCR processing results of a document image.

In a case where the pressing down of one of the destination buttons 1001 within the Destination screen 1000 in FIG. 10A is detected (S905), the client application 351 requests a corresponding folder navigation screen from the mediation server 111 (S1501). The remote control application 311 of the mediation server 111 requests a folder list from the business server 112 via the external system communication unit 334 (S1502). The business application 361 of the business server 112 having received the request sends the folder list (S1503). Then, the remote control application 311 of the mediation server 111 sends the folder navigation screen (S1504). The processing up to this point is the same as that of the GI portion in FIG. 9.

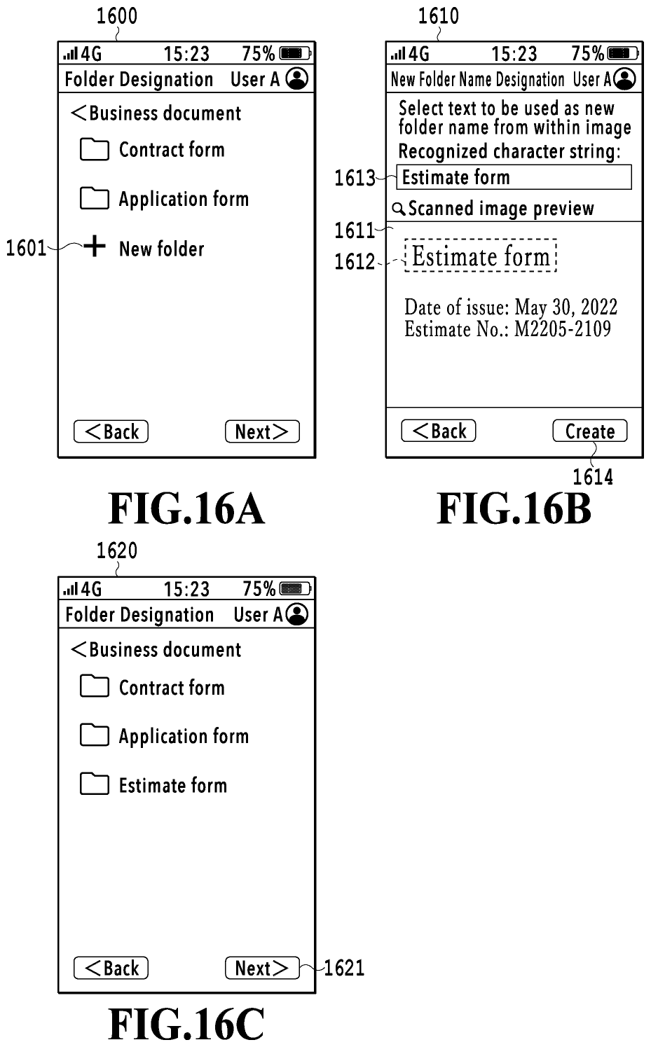

The client application 351 of the client terminal 121 having received the folder navigation screen displays the folder navigation screen 1010 shown in FIG. 10B described previously (S1505). In a case where the pressing down of the “Next” button 1012 is detected in the state where one of the folder icons 1011 within the folder navigation screen 1010 is selected, the client application 351 obtains the lower layer folder list thereof. Then, the client application 351 displays a folder navigation screen 1600 shown in FIG. 16A as the folder navigation screen in the hierarchical layer one layer below (S1505). The folder navigation screen 1600 shown in FIG. 16A is an example of the folder navigation screen in the hierarchical layer one layer below in a case where the folder icon of the “Business document” folder is selected within the folder navigation screen 1010. Here, it is assumed that the desired “Estimate form” folder is not created yet within “Business document”, which is the existing folder (current folder). Within the folder navigation screen 1600, a “New folder” icon 1601 for creating a new folder exists. In a case where the folder the user desires to use as the storage destination does not exist within the folder navigation screen 1600, the user presses down the “New folder” icon 1601. Upon detecting the pressing down of the “New folder” icon 1601 (S1506), the client application 351 requests a new folder name designation screen from the remote control application 311 of the mediation server 111 (S1507).

The remote control application 311 of the mediation server 111 sends the new folder name designation screen including the processing-target document image and the OCR processing results (recognized character string) thereof to the client terminal 121 (S1508).

The client application 351 of the client terminal 121 displays a New Folder Name Designation screen 1610 shown in FIG. 16B (S1509). On the New Folder Name Designation screen 1610, the processing-target document image is displayed within a preview area 1611. The user selects the area of a character string the user desires to use as the folder name from the document image being displayed (here, it is assumed that a character string area 1612 of “Estimate form” is selected) (S1510). The client application 351 detects the selection of the character string area such as this (S1510). The client application 351 displays the recognized character string corresponding to the character string area relating to the detected selection in a text edit field 1613 (S1511). Upon detecting the pressing down of a “Create” button 1614 (S1512), the client application 351 requests the remote control application 311 of the mediation server 111 to create a new folder (S1513). In this new folder creation request, the recognized character string selected by the user is included.

The remote control application 311 of the mediation server 111 requests the business server 112 to create a new folder via the external system communication unit 334 (S1514). The business application 361 of the business server 112 having received the request creates a folder using the recognized character string included in the request as the folder name and notifies the mediation server 111 of the creation of the new folder (S1515).

The remote control application 311 of the mediation server 111 having received the notification notifies the client terminal 121 of the creation of the new folder (S1516).

The client application 351 of the client terminal 121 displays a folder navigation screen 1620 shown in FIG. 16C, to which an icon representing the created new folder is added (S1517). In a case where the pressing down of a “Next” button 1621 is detected in the state where the created new folder is selected, the new folder is determined as the storage destination folder of the document file (S1518).

### Designation of File Name and Metadata

Next, with reference to the sequence diagram in FIG. 17, which is the sequence diagram following {F2} in each sequence diagram in FIG. 9, FIG. 11, FIG. 13, and FIG. 15 described previously, a method is explained in which a file name and metadata are designated by utilizing OCR processing results of a processing-target document image.

First, user instructions to designate a file name to be attached to a processing-target document image are given via a menu screen, not shown schematically. Here, it is assumed that the detection of the pressing down of the “Next” button on each UI screen in FIG. 10D, FIG. 12B, FIG. 14B, and FIG. 16C described previously is handled as user instructions to designate a file name and metadata. In a case where the user instructions are detected, the client application 351 of the client terminal 121 requests a file name designation screen from the remote control application 311 of the mediation server 111 (S1701). Then, the remote control application 311 of the mediation server 111 sends the file name designation screen including the document image and the OCR processing results thereof to the client terminal 121 (S1702).

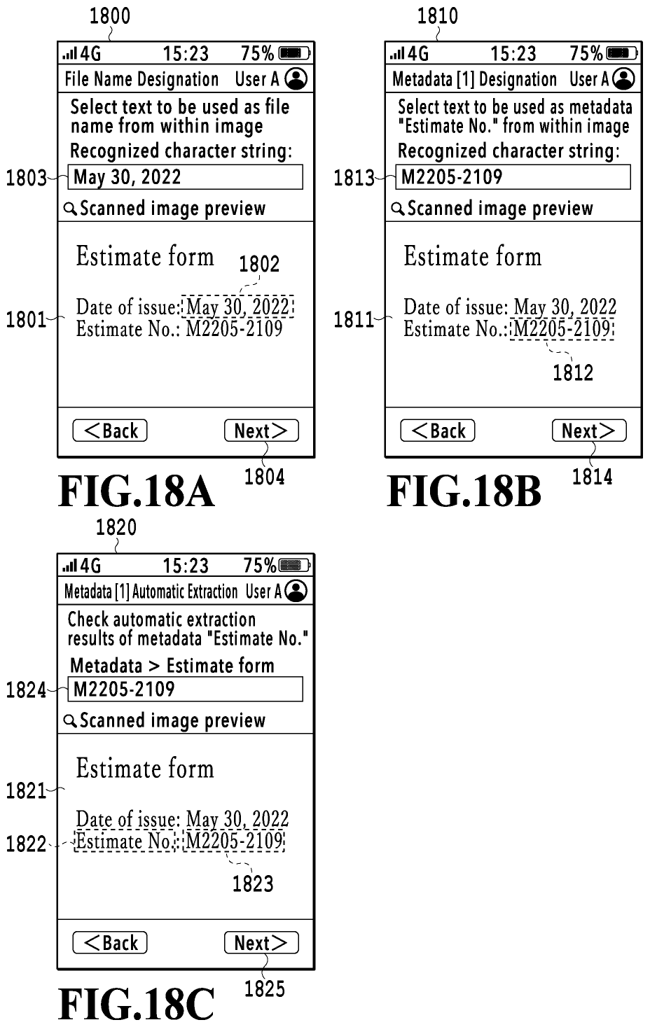

The client application 351 of the client terminal 121 having received the file name designation screen displays a File Name Designation screen 1800 shown in FIG. 18A (S1703). On the File Name Designation screen 1800, the processing-target document image is displayed in a preview area 1801. A user selects the area of a character string the user desires to use as a file name from the document image being preview-displayed (here, it is assumed that a character string area 1802 of “May 30, 2022” is selected). The client application 351 detects the selection of the character string area such as this (S1704). The client application 351 displays the recognized character string corresponding to the character string area relating to the detected selection in a text edit field 1803 (S1705). Then, in a case where the pressing down of a “Next” button 1804 is detected (S1706), the recognized character string being displayed in the text edit field 1803 at that point in time is determined as the file name of the document file. Then, the client application 351 requests a metadata designation screen from the remote control application 311 of the mediation server 111 (S1707). The remote control application 311 of the mediation server 111 requests metadata from the business server 112 via the external system communication unit 334 (S1708). The business application 361 of the business server 112 having received the request sends the corresponding metadata to the mediation server 111 (S1709).

The remote control application 311 of the mediation server 111 having received the metadata sends the metadata designation screen including the document image and the OCR processing results thereof to the client application 351 of the client terminal 121 (S1710).

The client application 351 of the client terminal 121 having received the metadata designation screen displays a metadata designation screen 1810 shown in FIG. 18B (S1711). On the metadata designation screen 1810, the processing-target document image is displayed within a preview area 1811. A user selects the area of a character string the user desires to use as metadata from the document image being displayed (here, it is assumed that a character string area 1812 of “M2205-2109” representing Estimate No. is selected). The client application 351 detects the selection of the character string area such as this (S1712). The client application 351 displays the recognized character string corresponding to the character string area relating to the detected selection in a text edit field 1813 (S1713). Then, in a case where the pressing down of a “Next” button 1814 is detected (S1714), the recognized character string being displayed in the text edit field 1813 at that point in time is determined as text information configuring metadata of the document file. As above, following the determination of the target storage destination folder, the file name and metadata of the document file are determined. It may also be possible to extract the character string corresponding to the predetermined item or the like determined in advance (generally called “key character string) from the OCR processing results and automatically display the character string in the above-described text edit field 1813 and a text edit field 1824 on the file name and metadata designation screen. FIG. 18C is one example of the metadata designation screen in a case where the character string corresponding to the key character string is displayed automatically. In this example, the character string “M2205-2109” representing “Estimate No.”, which is set in advance as the key character string of the metadata from the received OCR processing results, is displayed automatically in the text edit field 1824. Further, in a preview area 1821, each of character string areas 1822 and 1823 is displayed recognizably. In a case where there is no problem in the character string displayed automatically in the text edit field 18024, the user presses down a “Next” button 1825. As described above, it may also be possible to set the key character string in advance and extract the character string corresponding to the key character string from the OCR processing results and present the character string to the user by automatically displaying the character string. Due to this, it is possible to lighten the burden of the user.

### Destination Transmission

Next, with reference to the sequence diagram in FIG. 19, which is the sequence diagram following {F3} in the sequence diagram in FIG. 17 described previously, a method is explained in which a document file is transmitted to and stored in the designated storage destination folder.

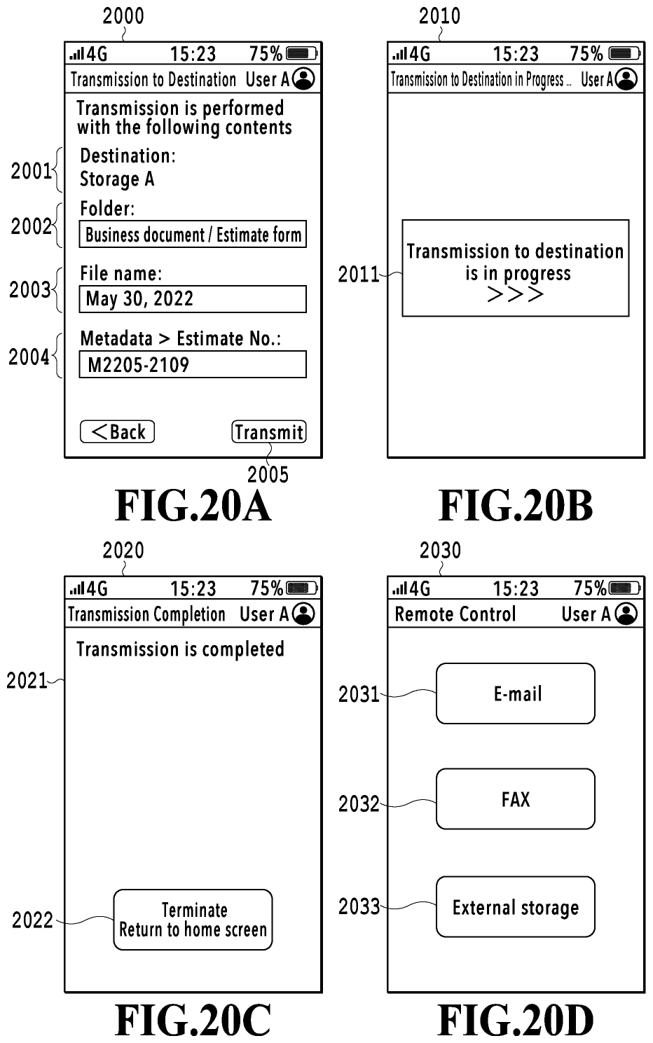

The client application 351 of the client terminal 121 displays a destination check screen 2000 shown in FIG. 20A (S1901). On the destination check screen 2000, “Destination” 2001 indicates the name of the business server to which a document file is transmitted. “Folder” 2002 indicates the folder name of the folder in which the document file is stored. “File name” 2003 indicates the file name of the document file. “Metadata” 2004 indicates the item as metadata and its value. In a case where there is no error in these contents relating to the destination, a user presses down a “Transmit” button 2005. Then, in a case where the pressing down of the “Transmit” button 2005 is detected (S1902), the client application 351 requests the remote control application 311 of the mediation server 111 to perform transmission (S1903). In this transmission request, transmission setting contents are included. Further, the client application 351 displays a transmission-in-progress screen 2010 shown in FIG. 20B (S1904). On the transmission-in-progress screen 2010, a status message 2011 indicating that transmission to the destination is in progress is displayed.

The remote control application 311 of the mediation server 111 having received the transmission request verifies the transmission setting contents (S1905). The items to be verified are different depending on the destination business server (application) and for example, whether a character type that cannot be used is included, whether the character string length is less than or equal to the maximum character string length, and the like are verified. In a case where the verification is completed, the backend application 331 of the mediation server 111 performs format conversion for the document file within the scanned document storage unit 322 as needed (S1906). For example, in a case where the document file includes a plurality of JPEG files, the document file is converted into a PDF file for integration into one file, and so on. Then, the backend application 331 requests the business server 112 to register the file via the external system communication unit 334 (S1907). In this file registration request, the full path of the storage destination folder, the file name, metadata and the like are included. Here, the full path of the storage destination folder is a unique path including the paths in all the hierarchical layers, such as “Business document/Estimate form” shown in “Folder” 2002. The business application 361 of the business server 112 notifies the mediation server 111 of the completion of the registration of the file (S1908).

In a case where the transmission processing of the document file to the destination is completed, the backend application 331 of the mediation server 111 removes the job for which the processing has been performed from the scanned document job queue 323 (S1909). Then, the remote control application 311 notifies the client application 351 of the client terminal 121 of the transmission results (S1910).

The client application 351 of the client terminal 121 having received the transmission results displays a transmission results screen 2020 shown in FIG. 20C (S1911). On the transmission result screen 2020, a transmission completion message 2021 indicating that the transmission processing of the document file is completed is displayed. Upon detecting the pressing down of a “Terminate” button 2022 within the transmission result screen 2020 (S1912), the client application 351 returns the screen display to the home screen 710 in FIG. 7B described previously (S1913).

The above is the flow of the series of processing from the conversion of the document image of the document into a digital file until the transmission to and storage in the business server.

### Second Embodiment

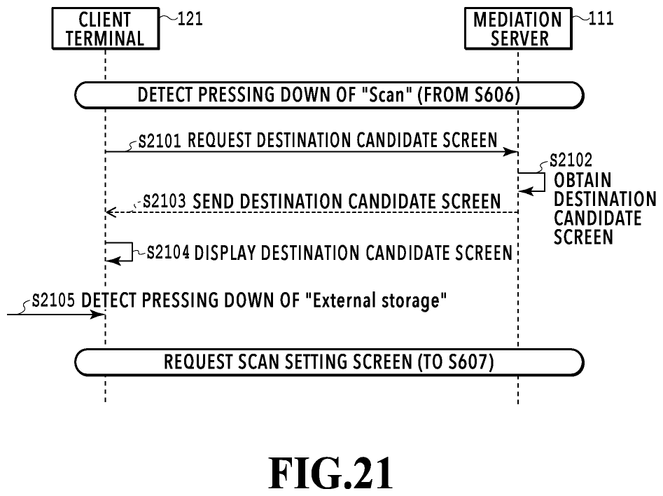

Next, an aspect is explained as a second embodiment, in which in a case where the client terminal 121 detects the pressing down of the “Scan” button 712 on the home screen 710, first, information on the transmission destinations available as the destination of a document file is obtained and a desired destination is selected from among them. FIG. 21 is a sequence diagram showing operations performed between the client terminal 121 and the mediation server 111 according to the present embodiment. In the following, points different from those of the first embodiment are explained mainly.

Upon detecting the pressing down of the Scan button 712 (S606), the client application 351 of the present embodiment requests a destination candidate screen from the remote control application 311 of the mediation server 111 (S2101).

The remote control application 311 having received the request first identifies the device ID and the model name of the client terminal 121 having made the request from the device data storage unit 325. Then, the remote control application 311 obtains information on the destinations that the identified model type of the client terminal 121 having made the request can utilize as the transmission destination of the document file (S2102). For obtaining the information, for example, it is sufficient to refer to a table or the like prepared in advance, in which a list of available destinations is described for each model type. Then, the remote control application 311 sends a destination candidate screen on which available destinations are enumerated to the client terminal 121 (S2103).

The client application 351 of the client terminal 121 having received the destination candidate screen displays a destination candidate screen 2030 shown in FIG. 20D (S2104). On the destination candidate screen 2030, “External storage” representing the business server 112 as the storage server and, in addition to this, “E-mail” and “FAX” that do not need to be relayed to the mediation server 111 are displayed as alternatives. With “E-mail” and “FAX”, it is possible for the multi function peripheral 131 itself to transmit a document file by using an E-mail transmission protocol and a FAX line and in a case where “E-mail” is selected, a user designates a mail address on a UI screen, not shown schematically, and in a case where “FAX” is selected, a user designates a FAX number in the same way. As above, it is possible for a user to designate file transmission in the aspect other than that of storage by selecting and operating each of buttons 2031 to 2033 corresponding to each destination. Then, upon detecting the pressing down of the “External storage” button 2033 (S2105), the client application 351 requests a scan setting screen from the mediation server 111 (S607). Subsequent steps are the same as those explained in the first embodiment.

As described above, it may also be possible to enable the selection of “E-mail” and “FAX” as the transmission destination of a transmission file, with which it is possible to perform transmission without the relay of the mediation server 111.

### Third Embodiment

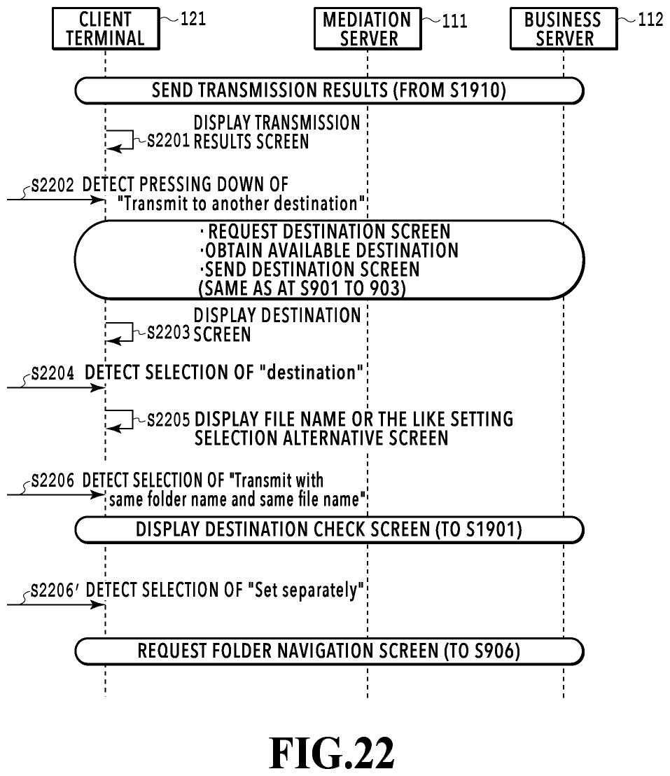

Next, an aspect is explained as a third embodiment, in which a button for transmission to another destination is provided within a transmission results screen so as to enable transmission also to a different destination. FIG. 22 is a sequence diagram showing operations performed between the client terminal 121, the mediation server 111, and the business server 112 according to the present embodiment. In the following, points different from those of the first embodiment are explained mainly.

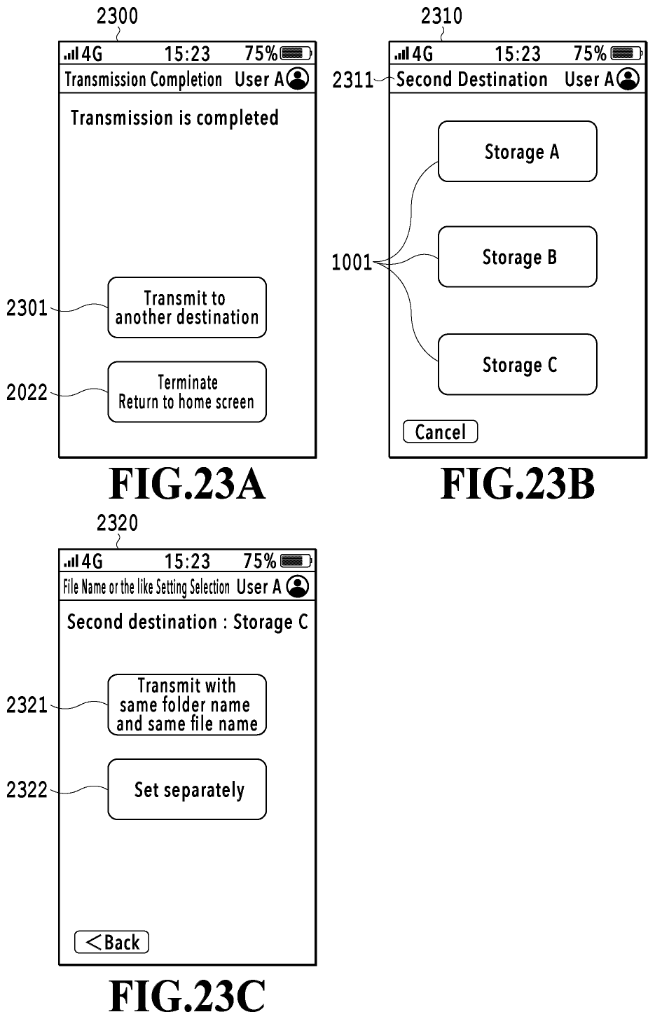

The client application 351 of the client terminal 121 having received the transmission results displays a transmission results screen 2300 shown in FIG. 23A (S2201). On the transmission results screen 2300, in addition to the “Terminate” button 2022, a “Transmit to another destination” button 2301 exists, which is selected in a case where sending to another destination is further desired. Upon detecting the pressing down of the “Transmit to another destination” button 2301 within the transmission results screen 2300 (S2202), the client application 351 requests a destination screen from the remote control application 311 of the mediation server 111 (same as at S901 described previously). Then, the remote control application 311 of the mediation server 111 obtains available transmission destinations and sends the destination screen to the client terminal 121 (same as at S902 and S903 described previously). Then, the client application 351 of the client terminal 121 having received the destination screen displays a destination screen 2310 shown in FIG. 23B (S2203). That is, the client application 351 causes the UI screen to make a transition into the state where it is possible to receive the user operation to designate a destination different from the destination for which the transmission has already been performed. On the destination screen 2310 in FIG. 23B, into which the transition has been made, a label 2311 indicating that the destination is the second destination is displayed. Upon detecting the pressing down of one of the destination buttons 1001 within the destination screen 2310 (S2204), the client application 351 displays a selection alternative screen 2320, shown in FIG. 23C, for setting a file name or the like (2205). On the selection alternative screen 2320, a button 2321 that is selected in a case where the same folder name and the file name as those of the first destination are used and a button 2322 that is selected in a case where the folder name and the file name are set anew exist. In a case where the pressing down of the button 2321 is detected (S2206), the client application 351 displays the destination check screen 2000 described previously (same as at S1901 described previously). After this, along the sequence diagram in FIG. 19 described previously, the transmission processing for the second destination is performed with the same folder name, the same file name, and the same metadata as those for the first destination being applied. On the other hand, in a case where the pressing down of the button 2322 is detected (S2206′), the client application 351 requests a folder navigation screen from the mediation server 111 (same as at S906 described previously). After this, along the sequence diagram in FIG. 9 described previously, as in the case of the first destination, the desired folder name, the file name, and the metadata are set anew and the transmission processing for the second destination is performed. It is needless to say that the same processing as that described above can be performed for the third and subsequent destinations.

### Other Embodiments

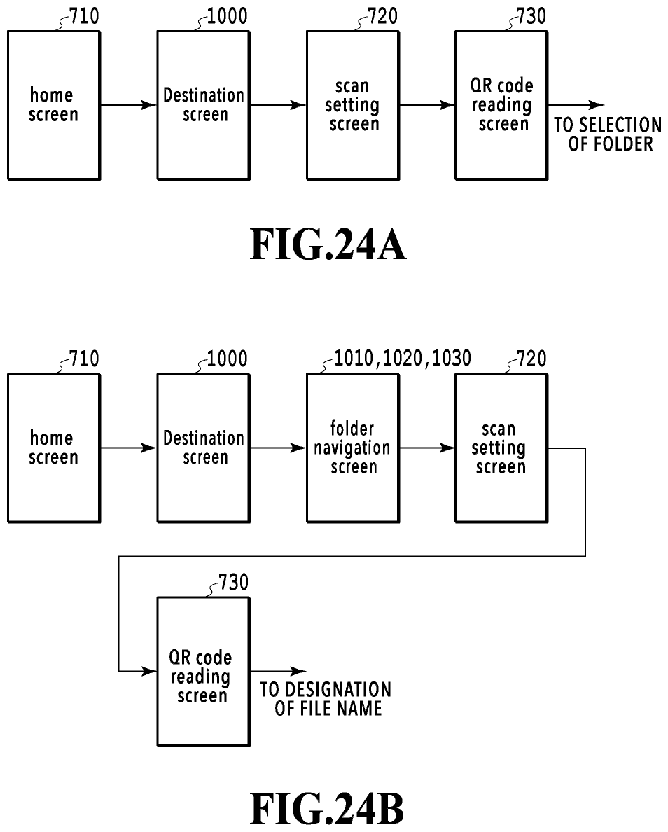

In addition to each embodiment described above, for example, such an embodiment may be possible in which in a case where instructions to scan a document are given on the home screen 710, the Destination screen 1000 is displayed before the scan setting screen 720 and after the destination is determined, the scan setting is performed as shown in FIG. 24A. Alternatively, for example, another embodiment may be possible in which in a case where instructions to scan a document are given on the home screen 710, the Destination screen 1000, the folder navigation screens 1010, 1020, and 1030 are displayed before the scan setting screen 720 as shown in FIG. 24B. That is, an embodiment may be possible in which the scan setting is performed after the destination and the folder are determined.

As above, according to each embodiment described previously, it is possible to offload the document scan, the designation of a folder name and a file name for a scanned document, the destination selection, the transmission instructions and the like to an information processing terminal that can be accessed remotely, such as a smartphone. Due to this, it is possible for a user to perform work efficiently by utilizing a smartphone or the like at hand irrespective of the size, specifications, and performance of the UI unit comprised by the scanner device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to efficiently perform a series of user operations from the paper document scan until document file transmission and storage without depending on the UI function of a scanner device.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-190258, filed Nov. 29, 2022 which is hereby incorporated by reference wherein in its entirety.

What is claimed is:

1. An information processing apparatus capable of communicating with an external device, the information processing apparatus comprising:
one or more memories storing instructions; and
one or more processors executing the instructions to perform:
giving first instructions to cause a first external device having a scan function to scan a document;
displaying a UI screen on a display unit, which receives a user operation for performing file transmission of a document image obtained by the scan; and
giving second instructions to cause a second external device, which has a function to obtain the document image from the first external device and perform file transmission, to perform file transmission of the document image based on a user operation received via the UI screen.

2. The information processing apparatus according to claim 1, wherein
the second external device performs OCR processing for the document image obtained from the first external device and
the one or more processors further execute the instructions to perform:
determining, based on a user operation to designate a character string area for the document image preview-displayed on the UI screen, predetermined information relating to file transmission by using results of the OCR processing for the designated character string area.

3. The information processing apparatus according to claim 2, wherein
the UI screen is configured to be capable of receiving a user operation for designating a destination of file transmission and
the second instructions are instructions to cause the second external device to perform file transmission of the document image to a destination designated based on a user operation to designate the destination via the UI screen.

4. The information processing apparatus according to claim 3, wherein
after file transmission of the document image to a first destination is completed, the UI screen makes a transition into a state capable of receiving a user operation to designate a second destination different from the first destination and
the second instructions are instructions to cause the second external device to perform file transmission of the document image to the second destination designated based on a user operation to designate the second destination via the UI screen after the transition.

5. The information processing apparatus according to claim 4, wherein
in a case where the second destination is designated via the UI screen after the transition, the UI screen makes a transition into a state capable of selecting whether to utilize the predetermined information on file transmission to the first destination as the predetermined information on file transmission to the second destination,
in the determining, the predetermined information on file transmission to the second destination is determined based on a user operation on the UI screen after the transition, and
the second instructions are instructions to cause the second external device to perform file transmission of the document image to the second destination.

6. The information processing apparatus according to claim 2, wherein
the predetermined information is a name of a folder used as a storage destination in a case where a file is transmitted and stored in a storage.

7. The information processing apparatus according to claim 6, wherein
the UI screen is configured to be capable of receiving a user operation for creating a new folder as a folder used as the storage destination and
in the determining, in a case where a user operation to designate creation of the new folder is received via the UI screen, a name of the new folder is determined by using results of the OCR processing for a character string area designated based on a user operation to designate the character string area for the document image preview-displayed on the UI screen.

8. The information processing apparatus according to claim 6, wherein
the UI screen is configured to be capable of receiving a user operation for searching for a folder as the storage destination from existing folders,
the one or more processors further execute the instructions to perform:
obtaining, in a case where a user operation to designate the search is received, search results by requesting the second external device to search for the existing folder by using results of the OCR processing for a character string area designated based on a user operation to designate the character string area for the document image preview-displayed on the UI screen, and
in the determining, a folder used as the storage destination is determined based on a user operation to select a specific folder via the UI screen on which the search results are displayed.

9. The information processing apparatus according to claim 2, wherein
the predetermined information is a file name in a case where a file is transmitted and stored in a storage.

10. The information processing apparatus according to claim 2, wherein
the predetermined information is metadata attached to a file of the document image in a case where a file is transmitted and stored in a storage.

11. The information processing apparatus according to claim 1, wherein
the second external device is a cloud server.

12. A control method of an information processing apparatus capable of communicating with an external device, the control method comprising the steps of:
giving first instructions to cause a first external device having a scan function to scan a document;
displaying a UI screen on a display unit, which receives a user operation for performing file transmission of a document image obtained by the scan; and
giving second instructions to cause a second external device, which has a function to obtain the document image from the first external device and perform file transmission, to perform file transmission of the document image based on a user operation received via the UI screen.

13. A non-transitory computer readable storage medium storing a program for causing a computer to perform a control method of an information processing apparatus capable of communicating with an external device, the control method comprising the steps of:
giving first instructions to cause a first external device having a scan function to scan a document;
displaying a UI screen on a display unit, which receives a user operation for performing file transmission of a document image obtained by the scan; and
giving second instructions to cause a second external device, which has a function to obtain the document image from the first external device and perform file transmission, to perform file transmission of the document image based on a user operation received via the UI screen.
